(19) United States
(12) Patent Application Publication
(10) Pub. No.: US 2007/0027724 A1
(43) Pub. Date: Feb. 1, 2007

(54) Divorce insurance

(76) Inventor: John A. Logan, Apex, NC (US)

Correspondence Address: JOHN A. LOGAN, 813 JAMES ST, APEX, NC, 27502, US

(21) Appl. No.: 11/192,543

(22) Filed: Jul. 30, 2005

(51) Int. Cl. G06Q 40/00

(52) U.S. Cl. 705/4

(57) ABSTRACT

This invention comprises a method of doing business involving providing Divorce Insurance individuals who may become parties of divorce (“dissolution” in some states) to protect them from financial difficulties as a result of a divorce, by providing one or more lump sum cash benefits.

### FIELD OF THE INVENTION

This invention comprises a method of doing business involving providing divorce insurance to individuals who may become parties of a divorce (“dissolution” in some states) to protect them from adverse financial consequences as the result of a divorce and provide them with a predetermined cash benefit claimed upon the presentation of a legally filed and finalized divorce decree together with policy documentation to the insurer.

### BACKGROUND OF THE INVENTION

No one gets married with the intention of getting divorced. However, no one plans on getting sick or injured either, yet there is accident and health insurance to provide financial assistance for those events.

America's divorce rate is nearly 50%, the highest rate among all nations of the world. Which means that men in the United States are as likely to get divorced as be diagnosed with Cancer yet no insurance covers divorce.

Insurance is provided for nearly every circumstantial risk except divorce. Yet divorce can be more financially devastating than serious illness or accident.

Most divorces happen between year 5 and year 10 of a marriage.

The average length of divorce proceedings is approximately 1 year. This does not include any child custody or property settlements, which often take several years.

The average cost of a divorce is $16,700.

Women file for divorce more than 3 times as often men. Financial independence has a direct bearing on whether a woman can or will initiate divorce proceedings. Women who are dependent on their spouse for their financial well-being are far less likely to initiate divorce proceedings even in the worse domestic scenarios unless they have a support net of family or friends that will support them financially in their time of need after their divorce.

The average age at first divorce is between 33-35.

22% of all divorces occur within the first 3 years.

38% of all divorces occur within the first 5 years.

65% of all divorces occur within 10 years.

90% of all divorces occur within 20 years.

There are 2.5 million people divorced in the U.S. each year.

The census bureaus project that 40-60% of second marriages will end in a second divorce.

On the average, it takes divorced women about 6-18 months to get awarded any kind of support (child or spousal). More than 30% never get any money that is due them.

Divorce is widely accepted by experts as the single greatest predictor of poverty for women and children. Many will suffer the financial impact of the divorce for many years. In fact, many divorces are in part, the result of out of control financial obligations.

Lack of financial support and limited financial resources for women and children, especially in the first years after the divorce is a major factor contributing to poverty.

### SUMMARY OF THE INVENTION

Divorce Insurance is developed to provide financial support that anyone might need during the period immediately divorce.

Divorce Insurance is designed to be easily accessible and applications will be submitted via the internet with no underwriting.

Divorce Insurance will be sold in “units” equal to specific dollar amounts.

1. A method of doing business comprising the sale of Divorce Insurance policies to individual policy holders, for which they pay a monthly insurance premium, which insurance provides a cash benefit upon the policy holder becoming divorced, comprising one or more cash payments.

2. The method of claim 1 in which the cash benefits are paid in a lump sum.

3. The method of claim 1 in which the benefits are paid to the policy holder.

4. The method of claim 1 in which the policy holder is either single or married.

5. The method of claim 1 in which applications are completed online via the internet.

6. The method of claim 1 in which applications require no underwriting as to likelihood of filing a claim.

7. The method of claim 1 in which the insurance premium is determined by the amount of cash benefits (sold in units) and any multiplier (additional percentage of the original premium cost) as prescribed by choice of any riders.

8. The method of claim 1 in which the policy premium is paid by automatic deduction via monthly debit from either a credit card or bank draft.

9. The method of claim 1 in which the policy premium is paid in periodic payments.

10. The method of claim 1 in which there is an initial waiting period of up to five years during which no benefits are paid.

12. The method of claim 1 in which a rider provides for a shortened waiting period in consideration of a higher monthly premium amount.

13. The method of claim 1 in which a rider provides for return of all premiums paid in the event of a divorce prior to the end of the waiting period or cancellation of the policy by the policy holder after its maturity date in consideration of a higher monthly premium amount.

14. The method of claim 1 in which a rider provides for payment of one half (50%) of the face value of the policy if a duly filed legal separation agreement is presented any time after the maturity date of the policy.

15. The method of claim 14 that if a legal separation rider claim is processed then the remaining 50% of the face value of the policy is paid upon presentation of a final divorce decree.

16. The method of claim 1 in which no benefit is paid for a standard policy until a final judgment has been rendered in the divorce.

17. The method of claim 1 in which policies that have reached their “maturity” (defined as the end of the initial waiting period) will grow in face value every year as long as premiums continue to be paid.

18. The method in claim 1 in which policies will be guaranteed renewable after their maturity date.

19. A divorce insurance policy will provide cash benefits to policy holders in the event of divorce or legal separation, for which they pay an insurance premiums in which the benefits comprise one or two cash payments.
